(19) United States
(12) Patent Application Publication
(10) Pub. No.: US 2012/0162973 A1
(43) Pub. Date: Jun. 28, 2012

(54) Hybrid hydro-electric shower light

(76) Inventor: Vandette Carter, Yorktown, NY (US)

(21) Appl. No.: 12/930,027

(22) Filed: Dec. 27, 2010

(51) Int. Cl. F21V 33/00

(52) U.S. Cl. 362/193

(57) ABSTRACT

A shower LED lighting system is disclosed consisting of a generator that provides electrical energy to a rechargeable battery. Said battery powers a LED light bulb using an energy conservation approach. In bright lighting condition from natural sunlight, a light sensor detects this condition, and uses the generator to recharge a battery for later use. During dim or poor light condition, the recharged battery provides electricity to the LED light bulb in a shower stall environment. Various embodiments of the invention can be realized; for example a newly designed showerhead as a entity that exist between a shower head and a water outlet pipe system.

### BACKGROUND OF THE INVENTION

The present invention relates to an apparatus for providing light source to a bathroom shower stall area. The invention uses a generator to power LED light or rechargeable batteries for fulfilling such purpose.

### PRIOR ART

The prior art have provided for various means of harnessing the hydropower of water to provide electricity and or LED lighting to a bathroom shower area using a simplified means of capturing the force of water and converting that to electrical energy. Others have done this by coupling a generator directly to a showerhead or providing an accessory between the showerhead and the pipe outlet. The drawback with this approach is that the regulatory flow of water is not always constant and the generator blades used for turning the electrical system in it self will impede the flow of water, thereby decreasing the pleasure of showering with high water flow rate etc. There are other numerous drawbacks with the prior arts. What is needed is a means to provide lighting without obstructing the flow of water, while maintaining the benefit of harnessing the hydropower of flowing water via a showerhead. The present invention overcomes these shortfalls by providing a hybrid rechargeable battery system, which is coupled to the generator. The rechargeable battery will provide electricity to the LED lights, while recapturing energy and converting that to electricity to be stored in the rechargeable battery for later use. Since LED uses very low energy, only a small fraction of water flow is diverted to turn a operate a small generator, which can then recharge said battery used to power the LED light. In this system, the LED lights get their power from the battery, which is then recharged incrementally by the generator. During bright conditions as during the day, a sensor may detect the presence of light in the shower area and conserve the LED use; thereby permitting the batteries to be recharged when natural light is present. When used under poor lighting condition, said sensor will permit the LED light to function, deriving power from the rechargeable battery.

### SUMMARY OF THE INVENTION

The invention is an LED shower light source, which uses power from a rechargeable battery, which is in turn, recharged by a generator. The system maybe coupled directly (built in) to a shower head, or exist and an embodiment that can be connected between the shower-head assembly and the pipe outlet within a shower stall area. Further, an electrical light sensor is provided, that determines and control the amount of light existing within the shower area. When there is adequate natural lighting (as during the morning hours), the battery is permitted to recharge for later use under poor lighting conditions, such as during the night or evening.

### BRIEF DESCRIPTION OF THE DRAWINGS

The aforementioned aspects and other features of the present invention are explained in the following description, taken in connection with the accompanying drawings, wherein:

FIG. 1 is a cross section side view of the invention; where as a showerhead is shown, coupled to one embodiment of the apparatus, which is linked to a water outlet pipe system.

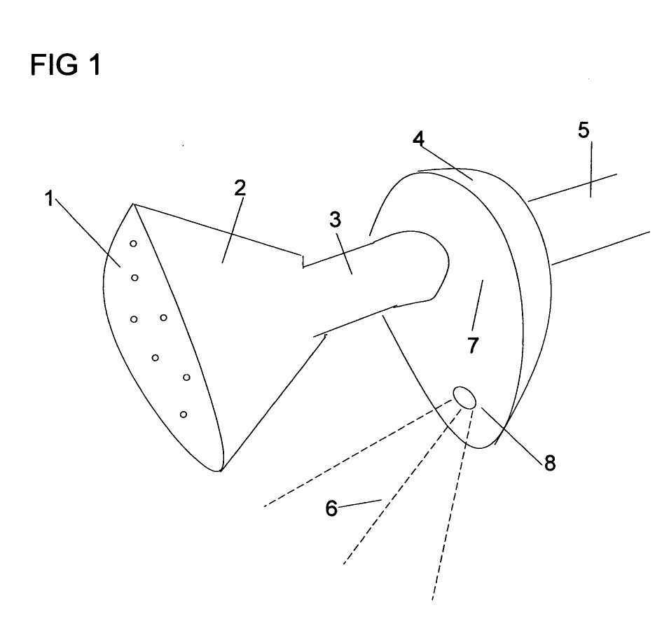

### DETAILED DESCRIPTION OF THE INVENTION

As described, a generator is provided with blades located within the path of the flowing water. Said blades will turn the magnetic field of a generator (which is well known in the art); said turning accomplished by the flow of water will generate enough electricity to power an LED light bulb to provide lighting directly. In this mode of operation, excess current is sent to a rechargeable battery for later use. Ideally, the LED is operated from the rechargeable batteries, and the generator will recharge said batteries when the energy level is low; thereby not obstructing the flow and energy of water dramatically.

It is understood by those skilled in the art that a generator can be positioned directly into the path of flowing water along with its blades, to capture the energy of the moving water. Conversely, the blades alone can be situated within the path of the flowing water, while the generator mechanism can be outside. Similarly, a list of options can be provided for both the location of the battery, LED bulb and generator as follow: (1) Assembly can be a separate entity to couple between existing shower heads and water outlet. (2) Assembly can be built into the showerhead directly. (3) Assembly can be divided in a combination of 1 & 2. Further the assembly will include a light sensor to detect the presence of adequate lighting inside the showerhead area.

1. An apparatus comprising of a rechargeable battery, generator, light sensor and LED light bulb as described; whereas the generator is built within or external to a showerhead;

2. An embodiment containing a generator, light sensor, rechargeable battery-securable between a showerhead and a water outlet pipe system in a shower area.

3. An apparatus in claims 1 and 2 used for providing lighting in a shower area, without interrupting the energy flow of water;

4. Apparatus of 1-3 which conserves the need and use of lighting in a shower area, by utilizing a light sensor

5. An apparatus of 1-5 which manages the energy needs of a LED light bulb, by using a rechargeable battery and restores its energy from a generator during low or zero light demand periods.
